(19) United States
(12) Patent Application Publication
(10) Pub. No.: US 2016/0203521 A1
(43) Pub. Date: Jul. 14, 2016

(54) INTERACTIVE ADVERTISEMENT IMAGING MATCHING SYSTEM AND OPERATION METHOD THEREOF

(71) Applicant: GAIAMOBI INC., New Taipei City (TW)

(72) Inventors: CHIH-YI CHO, NEW TAIPEI CITY (TW); CHUNG-YU HSIEH, NEW TAIPEI CITY (TW)

(21) Appl. No.: 14/680,116

(22) Filed: Apr. 7, 2015

(30) Foreign Application Priority Data
Jan. 9, 2015 (TW) 104100805

(51) Int. Cl. G06Q 30/02

(52) U.S. Cl. CPC G06Q 30/0267; G06Q 30/0269

(57) ABSTRACT

The present invention provides an interactive advertisement imaging matching system, which includes a mobile terminal, for transmitting or receiving a call invitation signal; and includes an advertisement server, which is for transmitting any advertisement towards the mobile terminal, in the duration of the call invitation signal. Moreover, the present invention also provides an interactive advertisement imaging matching system and operation method thereof.

### CROSS-REFERENCE TO RELATED APPLICATION

This application claims the priority of Taiwanese patent application No. 104100805, filed on Jan. 9, 2015, which is incorporated herewith by reference.

### BACKGROUND OF THE INVENTION

1. Field of the Invention

The present invention relates generally to an interactive advertisement imaging matching system and an operation method thereof, and more particularly, the present invention relates to an interactive advertisement imaging matching system and operation method thereof. Also, when the mobile terminal transmits or receives a call invitation signal, the matching advertisement content can be easily provided, on the basis of the user information of the mobile terminal.

2. The Prior Arts

As a result of the advancement of communication technologies, communication technologies not only enable communication of portable phones to be carried out, and various digital technologies such as the Internet, imaging, music and photography and the like may also be used in mobile terminals, for example, mobile communication terminals, smart phones, notebook computers and personal digital assistant, and as such gaining popularity.

A mobile terminal not only serves the function of a telephone, a mobile terminal can also serve multiple functions such as providing internet access, enable a user to download and enjoy videos, enjoy music, as well as taking and editing photographs. In particular, the mobile terminal has different components compared to the standard mobile phones, and the main characteristic is that the mobile terminal can be used according to need, for example, the mobile terminal can be used with a mobile application.

As such, the current advertisement systems provide advertisements to users by means of the internet, and the technology involved that enables the delivery of the advertisements by the current advertisement systems to users is by means of the mobile terminal The traditional advertisement services provided that can deliver the matching advertisements to users is also via the internet. If the advertisement services are provided via the internet, then the subjects that will be in contact with the advertisements cannot be confirmed, and therefore, whether the matching advertisements are suitable for users, and also the effects of the advertisements also cannot be confirmed.

### SUMMARY OF THE INVENTION

### Technical Problems to be Solved

The main objective of the present invention is to provide an interactive advertisement imaging matching system and an operation method thereof. Particularly, when a mobile terminal transmits or receives a call invitation signal, an interactive advertisement imaging matching system and an operation method thereof may be provided in accordance with user information of the mobile terminal.

### Technical Solutions

According to the embodiment of the present invention, the interactive advertisement imaging matching system may include a mobile terminal that transmits or receives a call invitation signal; and an advertisement server, for transmitting an advertisement content towards the mobile terminal in the duration while the call invitation signal is made.

According to the embodiment of the present invention, the mobile terminal executes the advertisement content application to broadcast the advertisement content that is transmitted by the advertisement server.

According to the embodiment of the present invention, when the mobile terminal executes the advertisement content application, the user information of the mobile terminal is transmitted to the advertisement server.

According to the embodiment of the present invention, the user information may include at least one of an age of the user, a sex of the user, a product of interest and an occupation of the user.

According to the embodiment of the present invention, the advertisement server may include a database server, for storing the user information and a plurality of advertisement contents; and a content provider server, for selecting the advertisement content that matches the user information from the plurality of advertisement contents, and for transmitting the advertisement content to the mobile terminal, when receiving or transmitting the call invitation signal.

According to the embodiment of the present invention, the database server may include a first database, for storing the user information; and a second database, for storing the plurality of advertisement contents under different categories on the basis of a network environment.

According to the embodiment of the present invention, the content provider server may include a network confirmation unit, for confirming the network environment of the mobile terminal when transmitting or receiving the call invitation signal; and a content delivery unit, enabling the advertisement content that corresponds to the network environment to be confirmed by the network confirmation unit, enabling the advertisement content that corresponds to the user information to be selected from the database server, and transmitting the advertisement content to the mobile terminal.

According to the embodiment of the present invention, the network confirmation unit transmits the network value invitation information to the mobile terminal, on the basis of the network value invitation information corresponding to the network value information transmitted by the mobile terminal and the amount of time required for the transmission of the network value signal, the network environment of the mobile terminal is confirmed.

According to the embodiment of the present invention, in the network confirmation unit, if the amount of time required belongs to a set time range, the network environment is confirmed as a 3G network environment. If the amount of time required does not belong to a set time range, the network environment is confirmed as a 4G network environment or a WiFi network environment.

According to the embodiment of the present invention, the network value information may include at least one of an encoding rate (ER), a video file size (VFS), total video duration (TVD) and a packet time rate (PTR).

According to the embodiment of the present invention, in the network confirmation unit, if the network environment satisfies at least one of the ER of 100 kbps, the VFS of 128 KB and the TVD of 55 seconds, the network environment is confirmed as a 3G network environment. If the network environment satisfies at least one of the ER of 300 kbps, the VFS of 256 KB and the TVD of 105 seconds, the network environment is confirmed as a 4G network environment or a WiFi network environment.

According to the embodiment of the present invention, the content delivery unit may select the advertisement content based on the user information by means of the advertisement content matching algorithm.

According to the embodiment of the present invention, when the advertisement server inputs the call start command or the call end command, the transmission of the advertisement content to the mobile terminal is ended.

According to the embodiment of the present invention, an interactive advertisement imaging matching operation method may include the steps of transmitting or receiving a call invitation signal by a mobile terminal; transmitting an advertisement content to the mobile terminal in the duration of the call invitation signal when the mobile terminal is connected to an advertisement server; and broadcasting the advertisement content by the mobile terminal.

According to the embodiment of the present invention, the step of transmitting may further include the steps of: confirming a network environment of the mobile terminal; selecting the advertisement content that matches the user information, from the plurality of advertisement contents that are stored under different categories by the network environment; and transmitting the advertisement content to the mobile terminal.

According to the embodiment of the present invention, in the step of confirming, the network value invitation information is transmitted, on the basis of the network value invitation information that corresponds to the network value information transmitted by the mobile terminal and the amount of time required for transmitting the network value signal, the network environment of the mobile terminal is confirmed.

According to the embodiment of the present invention, in the step of confirming, if the amount of time required belongs to a set time range, the network environment is then confirmed as a 3G network environment, if the amount of time required does not belong to a set time range, the network environment is then confirmed as a 4G network environment or a WiFi network environment.

According to the embodiment of the present invention, in the steps of selecting and transmitting, the advertisement content may be selected based on the user information by means of the advertisement content matching algorithm.

According to the embodiment of the present invention, after the step of broadcasting, when the mobile terminal is transmitting or receiving the call invitation signal, a call start command or a call end command is inputted, when the advertisement server inputs the call start command or call end command, the transmission of the advertisement content to the mobile is ended.

### Technical Effects

According to the embodiment of the present invention, the interactive advertisement imaging matching system and operation method thereof may have the following advantages. When the mobile terminal transmits or receives a call invitation signal, the advertisement content may be broadcasted in the mobile terminal in the duration when the call invitation signal is made based on the user's personal orientation and field of interest, such as sports, clothes, movies, travels and the like. That is to say, the advertisement content may be broadcasted during a waiting call, so as to enable the user to pay attention to the advertisement content. As such, the user may obtain information during the waiting call.

### BRIEF DESCRIPTION OF THE DRAWINGS

The present invention can be understood in more detail by reading the subsequent detailed description in conjunction with the examples and preferred exemplary embodiments made to the accompanying drawings, wherein:

FIG. 1 is a system diagram simply illustrating the interactive advertisement imaging matching system of an embodiment of the present invention.

FIG. 2 is a system block diagram showing the control structure of the interactive advertisement imaging matching system of an embodiment of the present invention.

FIG. 3 is a flow chart showing the operation method of the interactive advertisement imaging matching system of an embodiment of the present invention.

FIG. 4 is a flow chart showing the operation method of the interactive advertisement imaging matching system of the present invention, and in particular shows the operation method that is involved when the mobile terminal sends the call invitation signal.

FIG. 5 is a flow chart showing the operation method of the interactive advertisement imaging matching system of the present invention, and in particular shows the operation method that is involved when the mobile terminal receives the call invitation signal; and

FIG. 6 is a flow chart showing the interactive advertisement imaging matching system of an embodiment of the present invention, and in particular shows a flow chart of the operation method involved when the network environment of the mobile terminal is being confirmed.

### DETAILED DESCRIPTION OF THE PREFERRED EMBODIMENT

The accompanying drawings are included to provide a further understanding of the invention, and are incorporated in and constitute a part of this specification. The drawings illustrate the preferred exemplary embodiments of the invention and, together with the description, serve to explain the principles of the invention.

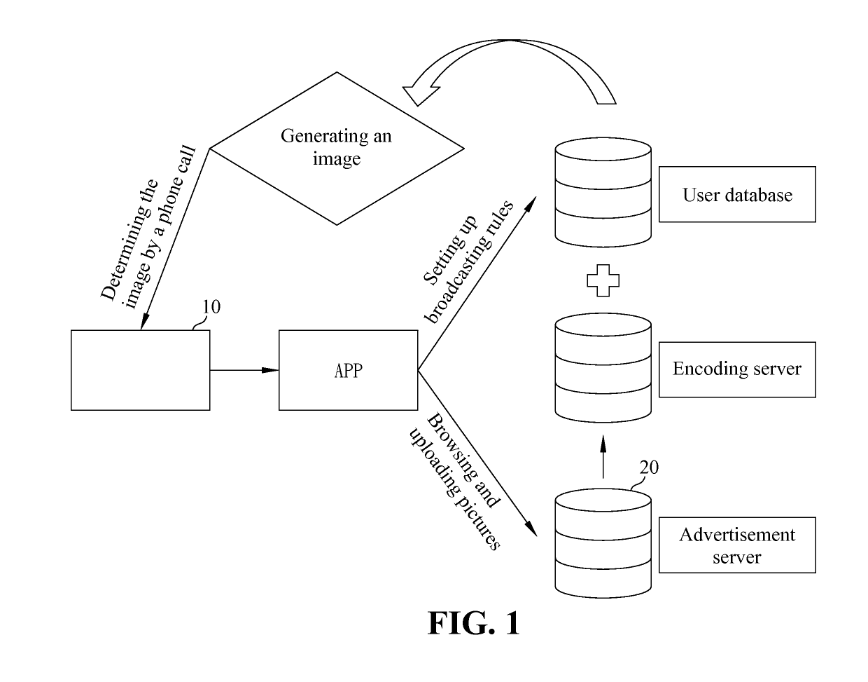

FIG. 1 is a system diagram simply illustrating the interactive advertisement imaging matching system of an embodiment of the present invention.

Referring to FIG. 1, the interactive advertisement imaging matching system may include a mobile terminal 10 and an advertisement server 20.

In accordance with a preferred exemplary embodiment of the present invention, the mobile terminal 10 may be a smart phone, and besides a smart phone, it may be a mobile communications terminal such as a cell phone, a notebook computer, a digital broadcasting terminal, a personal digital assistant, a portable multimedia player, a camera, a navigator, a tablet personal computer (PC), electronic book (e-book), but is not limited to these.

According to a preferred embodiment of the present invention, an advertisement content application used for accessing the advertisement server 20 may be set up on the mobile terminal 10. When the advertisement content application is being set up or being executed, the user information is inputted into the mobile terminal 10 in order for it to be transmitted to the advertisement server 20.

Subsequent to the execution of the advertisement content application by the mobile terminal 10, any other mobile terminal (not shown in the drawings) is used to transmit a call invitation signal for voice communication, or the call invitation signal for voice communication is received from the other mobile terminals. Then, the advertisement content that matches user information may be received from the advertisement server 20 for broadcasting.

After the advertisement server 20 has been executed and set up the advertisement application content in the mobile terminal 10, when the mobile terminal 10 transmits or receives the call invitation signal, the advertisement content is selected for transmission to the mobile terminal 10, the advertisement content will be transmitted to the mobile terminal 10 in light of the user information transmitted from the mobile terminal 10 and the network environment of the mobile terminal 10.

In other words, when the advertisement server 20 transmits or receives a call invitation signal at the mobile terminal 10, and in the duration of the call invitation signal being continuously transmitted or received, that is, the advertisement content is transmitted to the mobile terminal 10; when the mobile terminal 10 inputs the call start command or call end command of the call invitation signal, the advertisement content that is transmitted to the mobile terminal 10 may be ended.

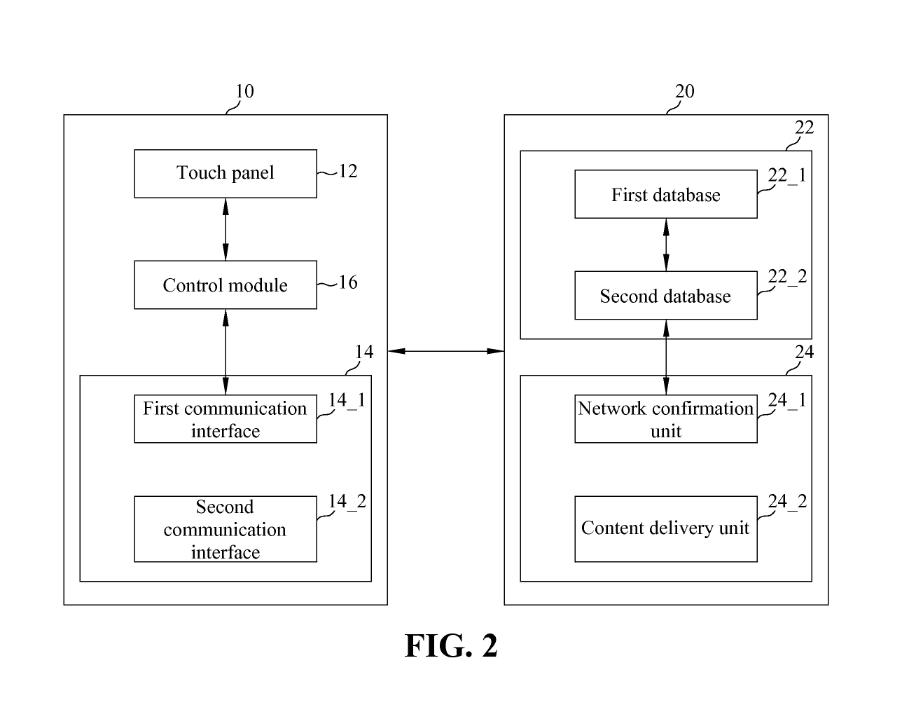

FIG. 2 is a system block diagram showing the control structure of the interactive advertisement imaging matching system of an embodiment of the present invention.

Referring to FIG. 2, the interactive advertisement imaging matching system of the present invention may include a mobile terminal 10 and an advertisement server 20.

The mobile terminal 10 may include a touch panel 12, a communication interface 14 and a control module 16.

The touch panel 12 shows a plurality of function applications, the user may input the call start command and the call end command the other mobile terminals (not shown in the drawings) that are used for voice communication.

In other words, the touch panel 12 may enable the input of the call start command and the call end command by touching, or the call start command and the call end command may be inputted by a physical button, but are not limited to these.

In a preferred embodiment of the present invention, each of the plurality of function applications may be in connection with the service providing server that provides a service, and this may include the advertisement content application that is in connection with the advertisement server 20 from the plurality of function applications.

In other words, the mobile terminal 10 may operate the touch panel 12 in order to set up and execute the advertisement content application. Following the execution of the advertisement content application, and in situations where the call invitation signal is transmitted or received by the other mobile terminals, these mobile terminals may be in connection with the advertisement server 20, but is not limited to these.

In addition, in situations where the control panel 12 sets up or executes the advertisement content application, the user information that corresponds to the user may be transmitted to the advertisement server 20 by means of the communication interface 14.

In accordance with a preferred embodiment of the present invention, the user information may include at least one of the user's age, sex, occupation and products of interest. When executing or setting the advertisement content application, and after inputting the visiting information such as visiting ID and PIN of the advertisement server 20, the user information may be inputted, but is not limited to these.

The communication interface 14 may include a first communication interface 14_1; the first communication interface 14_1 receives a voice signal for voice communication with the other mobile terminals. The communication interface 14 may also include a second communication interface 14_2, which is for performing data communication via the network and the advertisement server 20. The first communication interface 14_1 and the second communication interface 14_2 have been respectively described in the preferred embodiments of the present invention, but it may be a communication interface, but it is not limited to these.

In situations where the control module 16 sets up or executes the advertisement content application by means of the touch panel 12, so as to control the screen that corresponds to the advertisement content application, and the user information inputted by the user is shown on the touch panel 12. When executing the advertisement content application, the control is via the second communication interface 14_2, in order for at least one of the user information and the questioning information to be transmitted to the advertisement server 20. After the second communication interface 14_2 receives the advertisement transmitted from the advertisement server 20, the advertisement is shown on the touch panel 12.

The advertisement server 20 stores a plurality of advertisement contents. After the mobile terminal 10 executes the advertisement content application, in the process of receiving and transmitting the call invitation signal together with the other mobile terminals, and in the duration of having the call invitation signal, any advertisement content from the plurality of advertisement contents is selected and transmitted to the mobile terminal 10 and the other mobile terminals.

In accordance with a preferred embodiment of the present invention, the advertisement content is transmitted from the advertisement server 20 to the mobile terminal 10, and the advertisement content may also be transmitted to the other mobile terminals, but is not limited to these.

In other words, the advertisement server 20 may include a database server 22, which is used for storing the user information and the plurality of advertisement contents that are transmitted from the mobile terminal 10. Also, the content provider server 24 is for selecting and storing any advertisement content that matches the user information from the plurality of advertisement contents in the database server 24, and the content provider server 24 is also for the advertisement content to be transmitted to the mobile terminal 10, when the mobile terminal 10 receives or transmits the call invitation signal.

The database server 22 may include a first database 22_1, that is used for storing user information, and may include a second database 22_2, which is used for storing the plurality of advertisement contents under different categories according to the network environment.

Accordingly, when the first database 22_1 sets up or executes the advertisement content application in the mobile terminal 10, the user information may also be updated and stored.

When the first database 22 1 first sets up the advertisement content application in the mobile terminal, user information such as the login information may be received and also stored. Following this, when executing the advertisement content application, the corresponding user information is provided to the content provider server 24, in accordance with the login information, or when the user changes the user information, and this updated user information may be stored.

The second database 22_2 may store the plurality of advertisement contents under different categories according to the network environment, that is, the plurality of advertisement contents may be stored under WiFi network, 3G network and 4G network, and enabling the plurality of advertisement contents to be stored in the content provider server 24.

At this time, the second database 22_2 may receive a plurality of advertisement contents by means of the broadcasting station and the advertisement provider server, but is not limited to these.

The content provider server 24 may include a network confirmation unit 24_2 and a content delivery unit 24_4.

Following the execution of the advertisement content application by the network confirmation unit 24_2 at the mobile terminal 10, and at the same time of receiving or transmitting the call invitation signal, the network environment of the mobile terminal 10 is confirmed.

In other words, when the network confirmation unit 242 receives or transmits a call invitation signal at the mobile terminal 10, the transmission of the network value invitation signal to the mobile terminal 10 may be based on at least one of the network value invitation signal that is transmitted from the mobile terminal 10, and that this network value invitation signal corresponds to the network value information, and is also based on the amount of time required for the transmission of the network value info, in order for the network environment of the mobile terminal 10 to be confirmed.

For example, at the moment when the network confirmation unit 24_2 transmits the network value invitation signal to the mobile terminal 10, if the amount of time required for the transmission of the network value information from the mobile terminal belongs to a set time range, then the network environment of the mobile terminal 10 may be confirmed as a 3G network environment; if the amount of time required for the transmission of the network value information from the mobile terminal does not belong to a set time range, then the network environment may be confirmed as a 4G network environment or a WiFi network environment.

The network value information that is transmitted from the mobile terminal 10 may include at least one of an encoding rate (ER), video file size (VFS), total video duration (TVD) and packet time rate (PTR). The network confirmation unit 24_2 may confirm the most preferable network environment. If the network environment satisfies at least one of the ER of 100 kbps, the VFS of 128 KB and the TVD of 55 seconds, then the network environment may be confirmed as a 3G environment. If the network environment satisfies at least one of the ER of 300 kbps, the VFS of 256 KB and the TVD of 105 seconds, then the network environment may be confirmed as a 4G network environment or a WiFi environment, but not limited to these.

When the content delivery unit 24_4 transmits or receives the call invitation signal at the mobile terminal 10, the content delivery unit 24_4 receives and stores the user information that is within the database server 22, and (the content delivery unit 24_4) also selects the advertisement content that matches the users at the mobile terminal 10, by means of the advertisement content matching algorithm. The advertisement content that is stored in the database server 22 will be transmitted to the mobile terminal 10 in light of the network environment confirmed by the network confirmation unit 22_2.

The advertisement content matching algorithm uses at least one of the following information that is contained in the user information, such as the user's age, sex, products of interest and occupation, to select the matching advertisement content algorithm from the plurality of advertisement contents, but is not limited to these.

If at a time when the mobile terminal 10 transmits or receives the call invitation signal, and if at this time the user inputs the call start command or the call end command, then the content delivery unit 24_4 may end the transmission of the advertisement content.

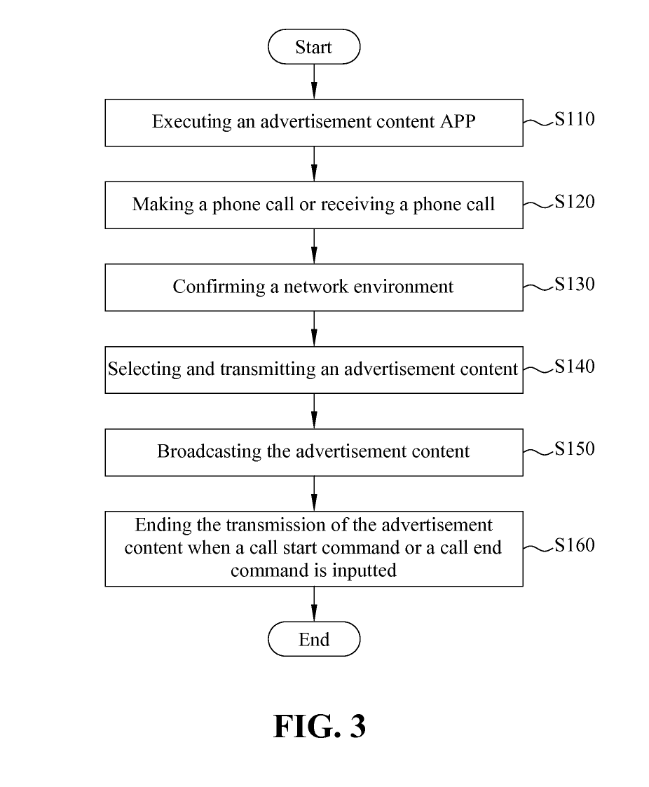

FIG. 3 is a flow chart showing the operation method of the interactive advertisement imaging matching system of an embodiment of the present invention.

Referring to FIG. 3, the mobile terminal 10 executes the advertisement content application that has been set up (step S110), and transmits or receives the call invitation signal (step S120).

That is, following the execution of the advertisement content application by the advertisement server 20 at the mobile terminal 10, the call invitation signal is transmitted to the other mobile terminals, or it may also be determined whether the call invitation signal is received from the other mobile terminals.

Here, the advertisement server 20 may check on a weekly basis whether the advertisement content application has been executed to transmit or receive the call invitation signal, but is not limited to this.

When the advertisement server 20 executes the advertisement content application at the mobile terminal 10, the user information is received by the mobile terminal 10 in order to confirm whether the advertisement content application has been executed.

The advertisement server 20 confirms the network environment of the mobile terminal 10 (step S130), when the network environment is confirmed, the advertisement server may select an advertisement content from the plurality of advertisement contents that matches the user information and that have been stored under different categories in accordance with the different network environments, and may transmit the advertisement content to the mobile terminal 10.

In other words, when the advertisement server 20 receives or transmits the call invitation signal, the advertisement server 20 transmits the network value invitation signal to the mobile terminal 10, and this transmission of the network value invitation signal to the mobile terminal is based on the network value transmitted from the mobile terminal 10, to confirm the network environment of the mobile terminal 10.

Accordingly, the network environment may include a 3G network environment, a 4G network environment and a WiFi network environment.

In addition, the advertisement server 20 may confirm the most preferable network environment among the 3G network environment, the 4G network environment and the WiFi network environment based on the network value transmitted by the mobile terminal 10.

Further, the advertisement server 20 may confirm the network environment based on the amount of time required for transmitting the network value invitation information to the mobile terminal 10 and the amount of time required for the transmission of the network value from the mobile terminal 10. Moreover, the network environment may be confirmed by using at least one of the two methods, but is not limited to this.

In addition to the above, the advertisement server 20 corresponds to the confirmed network environment, and transmits any of the plurality of advertisement contents to the mobile terminal 10.

Moreover, the advertisement server 20 may select the advertisement content on the basis of the advertisement content matching algorithm.

Following step S140, the mobile terminal 10 broadcasts the advertisement content transmitted from the advertisement server 20 (step S150), when the mobile terminal 10 inputs the call start command or call end command, the advertisement server 20 ends the transmission of the advertisement content (Step S160).

In other words, the advertisement server 20 transmits the selected advertisement content to the mobile terminal 10, and the mobile terminal 10 broadcasts the advertisement content on the basis of the advertisement content application.

At the time when the user inputs the call start command or call end command at the mobile terminal 10, the advertisement server 20 may end the transmission of the advertisement content.

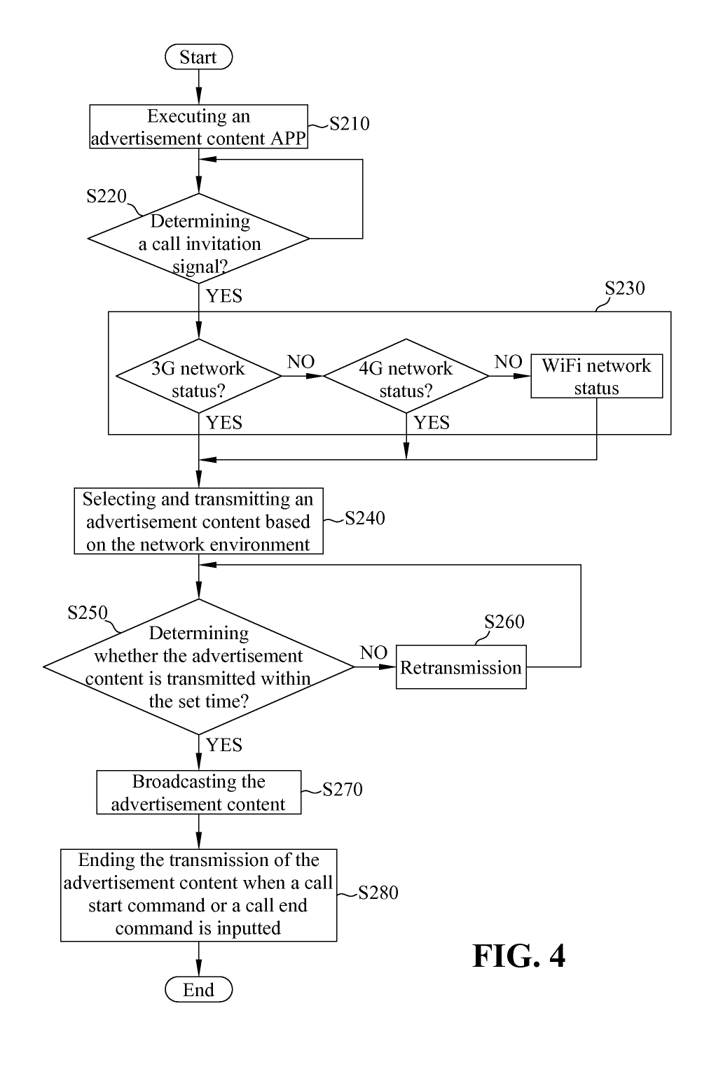

FIG. 4 is a flow chart showing the operation method of the interactive advertisement imaging matching system of the present invention, and in particular shows the operation method that is involved when the mobile terminal sends the call invitation signal.

FIG. 4 further illustrates a flow chart showing the operation method of the interactive advertisement imaging matching system shown in FIG. 3.

Referring to FIG. 4, the mobile terminal 10 executes the advertisement content application that has been set up (step S210), and the mobile terminal 10 determines whether or not to transmit the call invitation signal to the other mobile terminals (step S220).

To put in another way, after the execution of the advertisement content application by the advertisement server 20 at the mobile terminal 10, the advertisement server 20 determines whether or not to transmit the call invitation signal to the other mobile terminals, or determines whether the call invitation signal should be received by the other mobile terminals.

Accordingly, the advertisement server 20 may check on a weekly basis whether the advertisement content application has been executed, and that the call invitation signal has been transmitted or received, but is not limited to these.

When the advertisement server 20 executes the advertisement content application at the mobile terminal 10, the user information may be received from the mobile terminal 10, in order to confirm whether the advertisement content application has been executed.

The advertisement server 20 confirms the network environment of the mobile terminal 10 (step S230), when the network environment is confirmed, the advertisement server may select an advertisement content from the plurality of advertisement contents that matches the user information and that has been stored under different categories in accordance with the different network environments, and may transmit the advertisement content to the mobile terminal 10 (step S240).

In other words, when the advertisement server 20 transmits or receives the call invitation signal, the advertisement server 20 transmits the network value invitation signal to the mobile terminal 10, and the network environment of the mobile terminal 10 may be confirmed based on the network value that is transmitted from the mobile terminal 10.

Accordingly, the network environment may involve a 3G network environment, 4G network environment and WiFi environment.

Additionally, the advertisement server 20 may determine the most preferable network environment out of the 3G network environment, 4G network environment and WiFi network environment, on the basis of the network value transmitted from the mobile terminal 10.

Furthermore, the advertisement server 20 may confirm the network environment based on the amount of time required for transmitting the network value invitation information to the mobile terminal 10 and the amount of time required for the transmission of the network value from the mobile terminal 10. The advertisement server 20 may confirm the network environment by means of at least one of the methods, but is not limited to these.

Following that, the advertisement server 20 may transmit any of the plurality of advertisement contents stored in the advertisement server 20 to the mobile terminal 10 based on the recognized network environment.

According to the embodiment of the present invention, the advertisement server 20 may select the advertisement content by using the advertisement content matching algorithm in accordance with the user information.

After step S240, the advertisement server 20 may determine whether the advertisement content is transmitted to the mobile terminal 10 (step S250) within the set time. If the advertisement content is not transmitted, then the advertisement content will be retransmitted (step S260). The mobile terminal 10 may broadcast the advertisement content transmitted by the advertisement server 20 (step S270).

That is to say, the advertisement server 20 may transmit the selected advertisement content to the mobile terminal 10, and may confirm whether the advertisement content is transmitted to the mobile terminal 10 within the set time.

According to the embodiment of the present invention, the advertisement server 20 may retransmit the advertisement content to the mobile terminal 10 if the advertisement content is not transmitted to the mobile terminal.

Moreover, the mobile terminal 10 may broadcast the advertisement content that is transmitted by the advertisement server 20, and may display the playback time.

When the mobile terminal 10 inputs a call start command or call end command, the advertisement server 20 will stop transmitting the advertisement content (step S280).

In other words, the advertisement server 20 may determine whether the mobile terminal 10 inputs a call start command or a call end command. When a call start command or a call end command is inputted, the advertisement server 20 will stop transmitting the advertisement content.

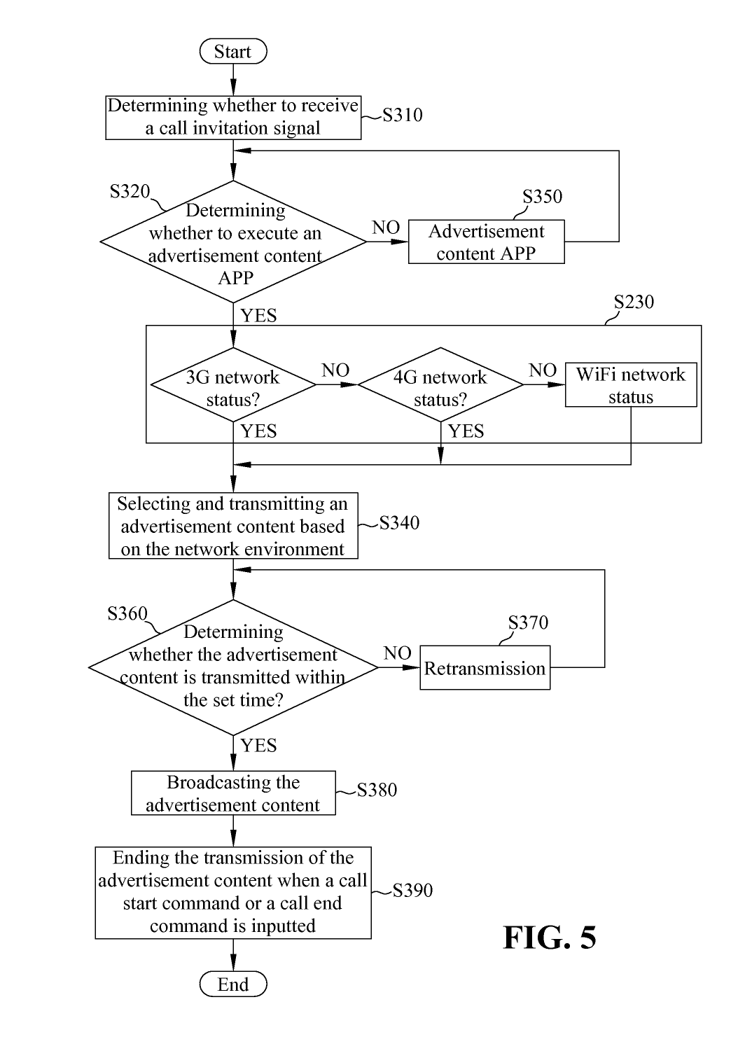

FIG. 5 illustrates a flow chart of an interactive advertisement imaging matching operation method when the mobile terminal 10 receives a call invitation signal.

FIG. 5 further illustrates the flow chart of the interactive advertisement imaging matching operation method, as shown in FIG. 3.

Referring to FIG. 5, the mobile terminal 10 may receive a call invitation signal from other mobile terminals (step S310). The advertisement server 20 may determine whether the mobile terminal 10 executes the advertisement content application (step S320).

That is, when the mobile terminal 10 receives a call invitation signal from other mobile terminals, the advertisement server 20 will determine whether the mobile terminal 10 executes the advertisement content application.

When the mobile terminal 10 executes the advertisement content application, the advertisement server 20 will confirm a network environment of the mobile terminal 10 (step S330). The advertisement server 20 may select any of the plurality of advertisement contents stored in the advertisement server 20 that matches the user information under different categories on the basis of the determined network environment, and may transmit the advertisement content to the mobile terminal 10 (step S340).

That is to say, if the advertisement server 20 executes the advertisement content application at the mobile terminal 10, the advertisement server 20 will transmit network value invitation information to the mobile terminal The advertisement server 20 may determine the network environment of the mobile terminal in accordance with the network value transmitted by the mobile terminal 10.

Moreover, the network environment may include a 3G network environment, a 4G network environment and a WiFi network environment.

Accordingly, according to the network value transmitted by the mobile terminal 10, the advertisement server 20 may confirm the most preferable network environment among the 3G network environment, the 4G network environment and the WiFi network environment.

In addition, during the required time in between the time required for the transmission of the network value invitation information by the mobile terminal 10 and the time required for the transmission of the network value by the mobile terminal 10, the advertisement server 20 may confirm the network environment, and may confirm the network environment by using at least one of the above methods, but not limited to the present invention.

Subsequently, according to the network environment confirmed by the advertisement server 20, the advertisement server 20 may transmit any of the plurality of the advertisement contents that are stored in the advertisement server 20 to the mobile terminal 10.

Moreover, the advertisement server 20 may select the advertisement content that matches the user information from the plurality of advertisement contents by means of the advertisement content matching algorithm.

Following step S320, when the advertisement server 20 does not execute the advertisement content application at the mobile terminal 10, the screen for transmitting the advertisement content or executing the advertisement content application may be transferred (step S350).

In other words, when the advertisement server 20 does not execute the advertisement content application at the mobile terminal 10, the advertisement content application is transmitted to enable the mobile terminal 10 to set up and execute the advertisement content application, or the executing screen that the mobile terminal 10 executes the advertisement content application is transferred so as to enable the user of the mobile terminal 10 to set up or execute the advertisement content application.

After step S340, the advertisement server 20 may determine whether the advertisement content is transmitted to the mobile terminal 10 within the set time (step S360). If the advertisement content is not transmitted, the advertisement content will be retransmitted (step S370). The mobile terminal 10 may broadcast the advertisement content that is transmitted by the advertisement server 20 (step S380).

In other words, the advertisement server 20 may transmit the selected advertisement content to the mobile terminal 10, and may determine whether the advertisement content is transmitted to the mobile terminal 10 within the set time.

When the advertisement content is not transmitted to the mobile terminal 10, the advertisement server 20 may retransmit the advertisement content.

Additionally, the mobile terminal 10 may broadcast the advertisement content that is transmitted by the advertisement server 20, and may display the advertisement information with regard to the play time and the advertisement content.

The advertisement information may include at least one of an advertiser registration number and billing information for advertising items, but not limited to the present invention.

When the advertisement server 20 inputs the call start command or the call end command at the mobile terminal 10, the transmission of the advertisement content to the mobile terminal 10 may be ended (step S390).

In other words, the advertisement server 20 may determine whether the advertisement server 20 inputs the call start command or the call end command at the mobile terminal 10. When the call start command or the call end command is inputted, the transmission of the advertisement content may be ended.

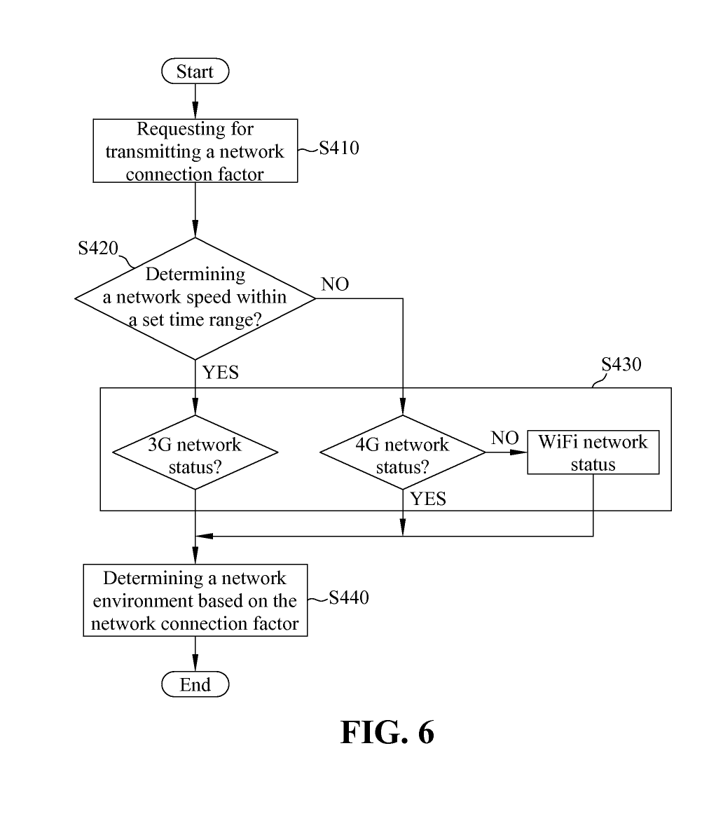

FIG. 6 shows a flow chart of an interactive advertisement imaging matching operation method that is used to confirm a network environment of a mobile terminal in an interactive advertisement imaging matching system.

Referring to FIG. 6, the advertisement server 20 may transmit the network value invitation information to the mobile terminal 10 (step S410), and may determine whether the time required for the transmission of the network value from the mobile terminal 10 is within a set time range (step S420).

That is, the advertisement server 20 may transmit the network value invitation information to the mobile terminal 10, and may confirm the required time between the time required for the transmission of the network value invitation information and the time required for the transmission of the network value from the mobile terminal 10.

If the amount of time required is within the set time range, the advertisement server 20 may confirm that the network environment is a 3G network environment. If the amount of time required is not within the set time range, the advertisement server 20 may confirm that the network environment is a 4G network environment or a WiFi network environment (step S430). The network environment may be confirmed finally based on the network value transmitted by the mobile terminal 10 (step S440).

That is, if the amount of time required is within the set time range, the network environment is then confirmed as a 3G network environment by the advertisement server 20. If the amount of time required is not within the set time range, then the network environment is confirmed as a 4G network environment or a WiFi network environment by the advertisement server 20.

Subsequently, if the network value is transmitted by the mobile terminal 10, that is, if the encoding rate is 100 kbps, the video file size is 128 KB and the total video duration is 55 seconds, the network environment is confirmed as a 3G network environment by the advertisement server 20. If the encoding rate is 300 kbps, the video file size is 256 KB and the total video duration is 105 seconds, the network environment is confirmed as a 4G network environment or a WiFi network environment by the advertisement server 20.

According to the interactive advertisement imaging matching system of an embodiment of the present invention, if the mobile terminal accesses the advertisement content application, the user information is transmitted to the advertisement server; that is, the advertisement server may transmit a list directory of the plurality of advertisement contents that are scheduled for broadcasting to the mobile terminal when the mobile terminal makes the call invitation signal within the set time. Subsequently, when the call invitation signal is made, information with regard to the plurality of advertisement contents may be transmitted to the mobile terminal, but not limited to the present invention.

According to an embodiment of the present invention, the interactive advertisement imaging matching system may transmit the advertisement content to the mobile terminals when the communication between mobile terminals is generated, such as the communications between mobile terminals or the communication between mobile terminals and other types of electronic devices. For example, the interactive advertisement imaging matching system may transmit the advertisement content to a laptop or a smart TV, but not limited to the present invention.

The above constituents of the embodiment of the present invention are not limited to the present invention. That is, all the above constituents of the present invention may be modified without departing from the scope of the present invention. Moreover, all the constituents of the present invention may be respectively constituted as independent hardware. Further, a part of or all parts of the constituents may also be selectively constituted as computer programming based on a part of or all parts of the programming modules that are executed in hardware. In addition, the computer programming may be stored in computer readable media, such as a USB memory, a compact disc and a flash memory, but not limited to the present invention. The computer programming may be accessed and executed so as to achieve the embodiment of the present invention. The computer readable media may also include magnetic recording media, optical recording media, carrier wave media and so on, but not limited to the present invention.

Furthermore, while the system and method described herein are provided with a certain degree of specificity, the present invention can be implemented with either greater or lesser specificity, depending on users' needs. Additionally, some of the features of the present invention can be used to advantage without the corresponding use of other features. Accordingly, the foresaid description should be considered as simply illustrative of the principles of the present invention, and not in limitation thereof.

Although the preferred exemplary embodiments of the present invention have been described with reference to the preferred exemplary embodiments thereof, it may be apparent to those ordinarily skilled in the art that a variety of modifications and changes may be made without departing from the scope of the present invention which is intended to be defined by the appended claims.

What is claimed is:

1. An interactive advertisement imaging matching system, comprising:
a mobile terminal, transmitting or receiving a call invitation signal; and
an advertisement server, transmitting an advertisement content towards the mobile terminal in the duration when the call invitation signal is made.

2. The interactive advertisement imaging matching system in accordance with claim 1, wherein the mobile terminal is set up for an advertisement content application, the advertisement content application broadcasts the advertisement content via the advertisement server; when the mobile terminal executes the advertisement content application, a user information of the mobile terminal is transmitted to the advertisement server; the user information comprises at least one of an age of the user, a sex of the user, a product of interest and an occupation of the user; and when the mobile terminal is transmitting or receiving the call invitation signal, a call start command or an call end command is inputted, when the advertisement server inputs the call start command or call end command, the transmission of the advertisement content to the mobile terminal is ended.

3. The interactive advertisement imaging matching system in accordance with claim 1, wherein when the mobile terminal executes the advertisement content application to broadcast the advertisement content that is transmitted by the advertisement server, the user information of the mobile terminal is transmitted to the advertisement server, and the advertisement server comprises:
a database server, storing the user information and a plurality of advertisement contents; and
a content provider server, selecting the advertisement content that matches the user information from the plurality of advertisement contents, and transmitting the advertisement content to the mobile terminal, when receiving or transmitting the call invitation signal, wherein the database server comprises:
a first database, storing the user information; and
a second database, storing the plurality of advertisement contents under different categories on the basis of a network environment,
wherein the content provider server comprises:
a network confirmation unit, confirming the network environment of the mobile terminal when transmitting or receiving the call invitation signal; and
a content delivery unit, enabling the advertisement content that corresponds to the network environment confirmed by the network confirmation unit, selecting the advertisement content that corresponds to the user information from the database server, and transmitting the advertisement content to the mobile terminal, wherein the content delivery unit selects the advertisement content on the basis of the user information using an advertisement content matching algorithm.

4. The interactive advertisement imaging matching system in accordance with claim 3, wherein the network confirmation unit transmits network value invitation information to the mobile terminal, on the basis of the network value invitation information corresponding to the network value information transmitted by the mobile terminal and the amount of time required for the transmission of the network value signal, the network environment of the mobile terminal is confirmed, wherein in the network confirmation unit, if the amount of time required belongs to a set time range, the network environment is then confirmed as a 3G network environment, if the amount of time required does not belong to a set time range, then the network environment is confirmed as a 4G network environment or a WiFi network environment.

5. The interactive advertisement imaging matching system in accordance with claim 3, wherein the network value information comprises at least one of an encoding rate, a video file size, a total video duration and a packet time rate, wherein in the network confirmation unit, if the network environment satisfies at least one of the encoding rate (ER) of 100 kbps, the video file size (VFS) of 128 KB and the total video duration (TVD) of 55 seconds, the network environment is confirmed as a 3G network environment, or if the network environment satisfies at least one of the ER of 300 kbps, the VFS of 256 KB and the TVD of 105 seconds, the network environment is confirmed as a 4G network environment or a WiFi network environment.

6. An interactive advertisement imaging matching operation method, comprising the steps of:
transmitting or receiving a call invitation signal by a mobile terminal;
transmitting an advertisement content to the mobile terminal in the duration of the call invitation signal when the mobile terminal is connected to an advertisement server; and
broadcasting the advertisement content by the mobile terminal.

7. The interactive advertisement imaging matching operation method in accordance with claim 6, further comprising a step of transmitting the user information from the mobile terminal to the advertisement server, when the mobile terminal executes an advertisement content application of the advertisement content, before the mobile terminal transmits or receives the call invitation signal.

8. The interactive advertisement imaging matching operation method in accordance with claim 7, wherein the step of transmitting comprises the steps of: confirming a network environment of the mobile terminal; selecting the advertisement content that matches the user information, from the plurality of advertisement contents that are stored under different categories by the network environment; and transmitting the advertisement content to the mobile terminal, whereby in the step of confirming, the network value invitation information is transmitted, on the basis of the network value invitation information that corresponds to the network value information transmitted by the mobile terminal and the amount of time required for transmitting the network value signal, the network environment of the mobile terminal is confirmed; in the step of confirming, if the amount of time required belongs to a set time range, the network environment is then confirmed as a 3G network environment, if the amount of time required does not belong to a set time range, the network environment is then confirmed as a 4G network environment or a WiFi network environment.

9. The interactive advertisement imaging matching operation method in accordance with claim 8, wherein the network value information comprises at least one of an encoding rate, a video file size, a total video duration and the packet time rate; in the step of confirming, if the network environment satisfies at least one of the encoding rate (ER) of 100 kbps, the video file size (VFS) of 128 KB and the total video duration (TVD) of 55 seconds, the network environment is confirmed as a 3G network environment, or if the network environment satisfies the ER of 300 kbps, the VFS of 236 KB and the TVD of 105 seconds, the network environment is then confirmed as a 4G network environment or WiFi network environment; in the steps of selecting and confirming, the advertisement content is selected by means of the advertisement content matching algorithm, for matching user information.

10. The interactive advertisement imaging matching operation method in accordance with claim 8, wherein after the step of broadcasting, when the mobile terminal is transmitting or receiving the call invitation signal, a call start command or an call end command is inputted, when the advertisement server inputs the call start command or call end command, the transmission of the advertisement content to the mobile is ended.
